(19) United States
(12) Patent Application Publication
(10) Pub. No.: US 2019/0149013 A1
(43) Pub. Date: May 16, 2019

(54) ELECTRIC ROTATING MACHINE

(71) Applicant: Industrial Technology Research Institute, Hsin-chu (TW)

(72) Inventors: Huan-Lung Gu, Hualien County (TW); Shao-Yu Lee, Hsinchu County (TW); Shih-Kai Hsieh, Taoyuan City (TW); Kao-Hone Chu, Kaohsiung City (TW); Ching-Jin Tyan, Hsinchu County (TW)

(21) Appl. No.: 15/845,659

(22) Filed: Dec. 18, 2017

(30) Foreign Application Priority Data
Nov. 14, 2017 (TW) 106139345

(51) Int. Cl. H02K 5/18; H02K 1/32; H02K 1/04; H02K 3/51; H02K 5/06; H02K 11/33

(52) U.S. Cl. CPC H02K 5/18; H02K 1/32; H02K 11/33; H02K 3/51; H02K 5/06; H02K 1/04

(57) ABSTRACT

An electric rotating machine includes a stator housing, a rotor set, a stator set, at least one controlling room, and at least one drive controller. The rotor set is located inside the stator housing. The stator set is located inside the stator housing by surrounding the rotor set. The at least one controlling room is located aside to the stator housing. The at least one drive controller is located inside the controlling room.

### CROSS REFERENCE TO RELATED APPLICATION

This application claims the benefits of Taiwan application Serial No. 106139345, filed Nov. 14, 2017, the disclosures of which are incorporated by references herein in its entirety.

### TECHNICAL FIELD

The present disclosure relates in general to an electric rotating machine, and more particularly to the electric rotating machine that can provide superior design flexibility, raise heat-dissipating efficiency, enhance reliability of electronic components in quality, and reduce noise signals received by the circuits.

### BACKGROUND

One of normal topics demanded upon an electric vehicle, such as an electric motorcycle or an electric automobile, is to increase the power density of vehicle's power system; namely, to increase the output power and to minimize the size at the same time. Among various efforts to minimize the size, the mechatronics is now the mainstream technology in developing the electric rotating machine for advanced electric vehicles, in which the mechatronics is a technology to integrate structurally and electrically the electric rotating machine and the corresponding drive controller into a unique piece so as to reduce the entire volume of the machine.

Currently, three structural patterns of the mechatronics are usually seen in the art. One is an integrated structure in a radial outer surface manner, in which the drive controller is integrated to a radial outer surface of a stator housing of the electric rotating machine. Another is an integrated structure in an axial and internal manner, in which the drive controller is integrated to an axial internal space of stator housing of the electric rotating machine. The third one is an integrated structure in an axial and external manner in which the drive controller is integrated to an axial external space of the stator housing of the electric rotating machine. That is the drive controller is located distantly to a side for outputting loading.

In the aforesaid first structural pattern, radial mounting is applied, and thus a width or height of the electric rotating machine in a radial direction would be increased. On the other hand, in both the aforesaid second and third structural patterns, axial mounting is applied, and thus a length of the electric rotating machine in an axial direction would be increased.

It is understood that the main goal of mechatronics is to minimize the entire occupied space by the machine and to increase the power density. However, the reduction in the occupied space would squeeze the available assembling space, and thus would lead to various problems, including design difficulty, assembling difficulty, heat-dissipating difficulty, quality down in assembly, thermal interference upon electronic components, electromagnetic radiation interference upon control circuits and so on.

### SUMMARY

In one embodiment of this disclosure, an electric rotating machine includes a stator housing, a rotor set, a stator set, at least one controlling room, and at least one drive controller. The rotor set is located inside the stator housing. The stator set is located inside the stator housing by surrounding the rotor set. The at least one controlling room is located aside to the stator housing. The at least one drive controller is located inside the controlling room.

In another embodiment of this disclosure, an electric rotating machine includes a stator housing, a rotor set, a stator set, at least one controlling room, at least one drive controller, and at least one controlling-room cover. The rotor set is located inside the stator housing. The stator set is located inside the stator housing by surrounding the rotor set. The at least one controlling room is located aside to the stator housing. The at least one drive controller is located inside the controlling room. The at least one controlling-room cover is to seal the controlling room.

Further scope of applicability of the present application will become more apparent from the detailed description given hereinafter. However, it should be understood that the detailed description and specific examples, while indicating exemplary embodiments of the disclosure, are given by way of illustration only, since various changes and modifications within the spirit and scope of the disclosure will become apparent to those skilled in the art from this detailed description.

### BRIEF DESCRIPTION OF THE DRAWINGS

The present disclosure will become more fully understood from the detailed description given herein below and the accompanying drawings which are given by way of illustration only, and thus are not limitative of the present disclosure and wherein:

FIG. 1 is a schematically partly exploded view of a first embodiment of the electric rotating machine in accordance with this disclosure;

FIG. 2 is a schematic horizontal cross-sectional view of FIG. 1;

FIG. 3 is a schematic perspective view of part of FIG. 1;

FIG. 4 is a schematic horizontal cross-sectional view of FIG. 3;

FIG. 5 is a schematic cross-sectional view of FIG. 4 along a cross-sectional line thereof;

FIG. 6 is a schematic cross-sectional view of a second embodiment of the electric rotating machine in accordance with this disclosure; and

FIG. 7 is a schematic cross-sectional view of FIG. 6 along a cross-sectional line thereof.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

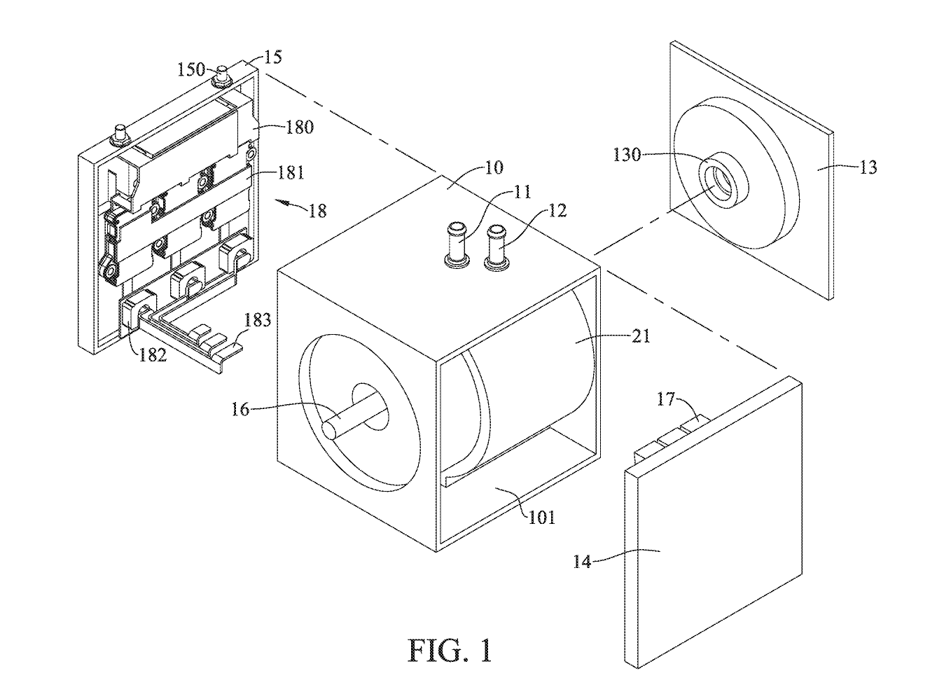

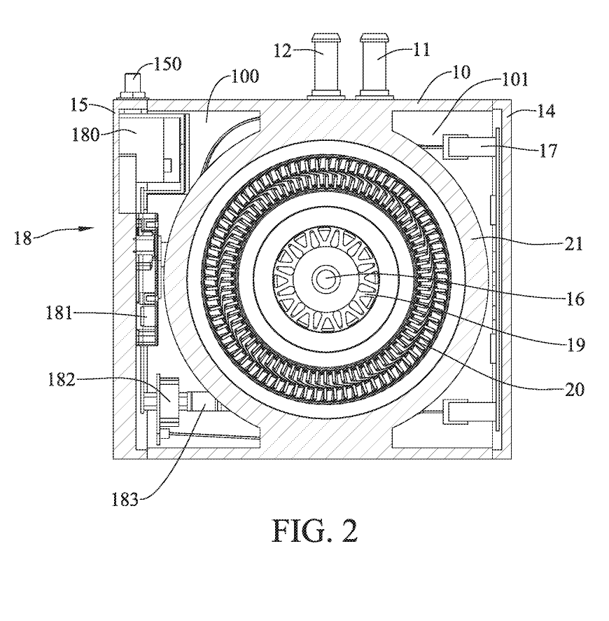

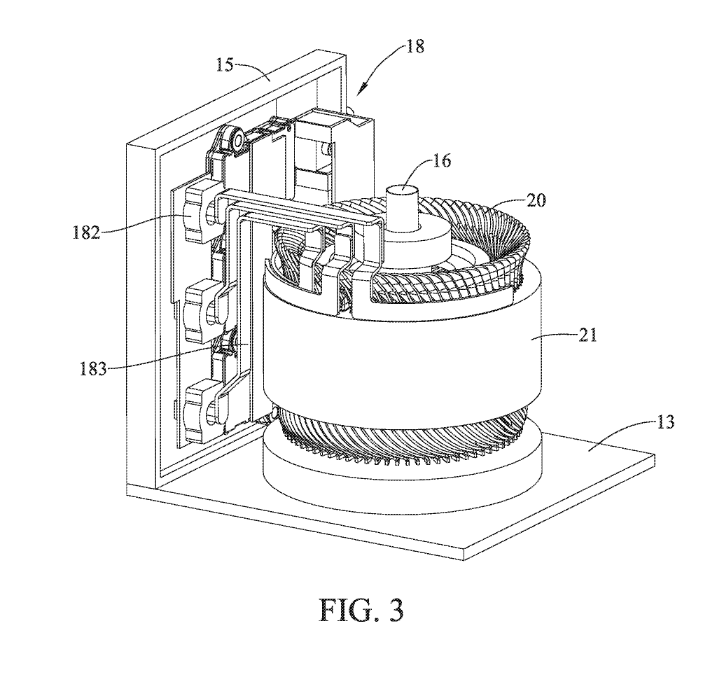

Referring now to FIG. 1, FIG. 2 and FIG. 3, a first embodiment of the electric rotating machine includes a housing 10, a cooling outlet 11, a cooling inlet 12, a rear bearing seat 13, a first controlling-room cover 15, a second controlling-room cover 14, a spindle 16, a first drive controller 18, a second drive controller 17, a rotor set 19, a stator set 20, a stator housing 21 and a cooling fan 22.

The housing 10 has a first controlling room 100 and a second controlling room 101. The cooling outlet 11 and the cooling inlet 12 are both disposed at the housing 10. A hole able to pass a connection wire therethrough is furnished between the first controlling room 100 and the second controlling room 101.

The rear bearing seat 13, disposed to an end portion of the housing 10, has a rear bearing 130.

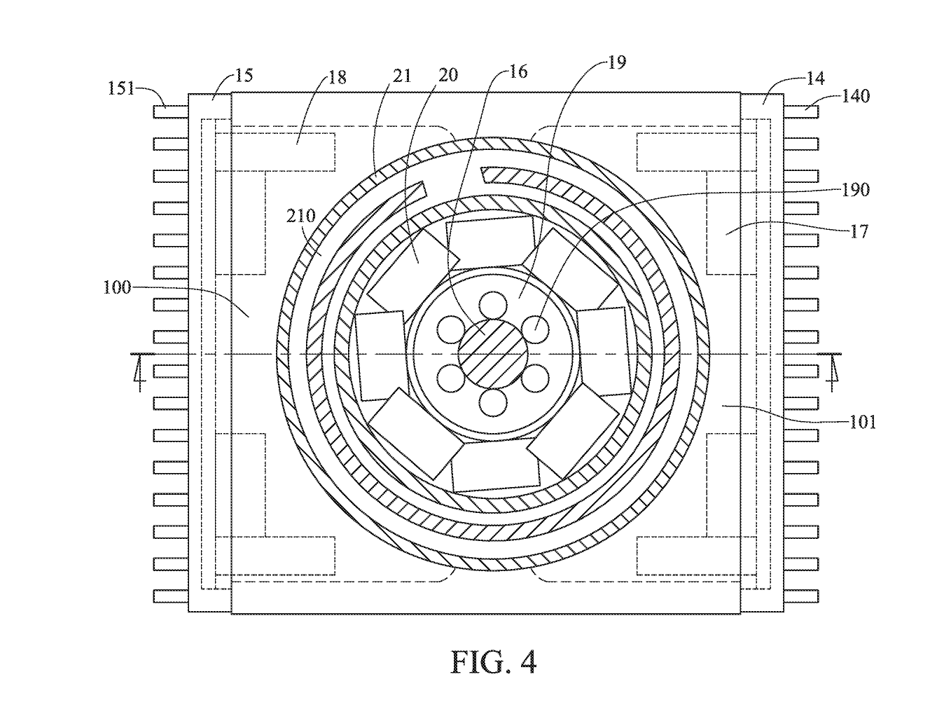

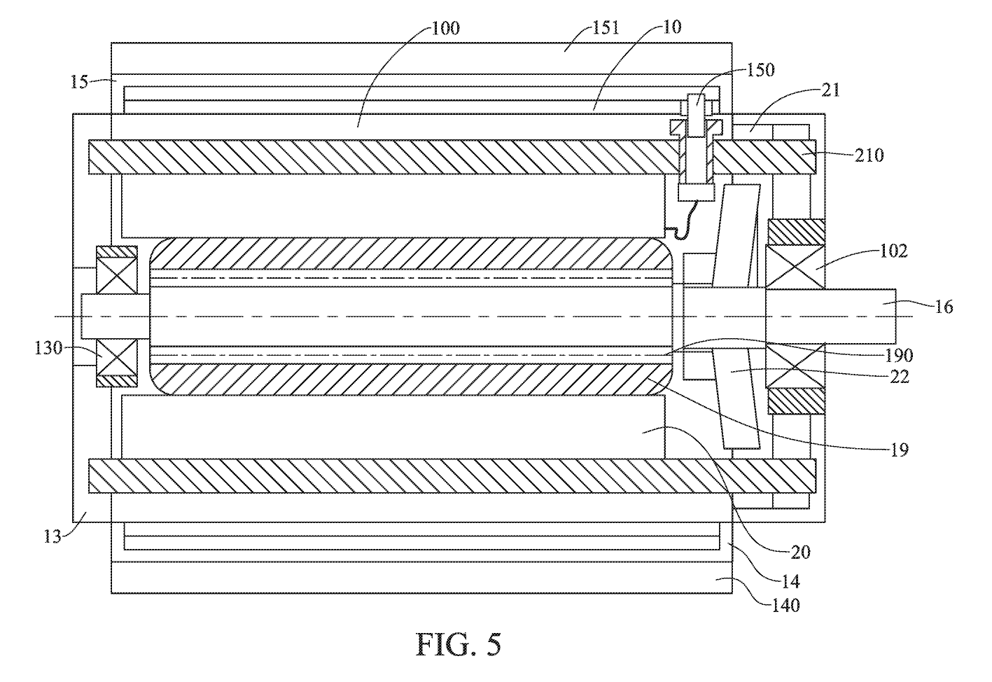

Referring now to FIG. 4 and FIG. 5, the first controlling-room cover 15 is furnished to one side of the housing 10 so as to seal the first controlling room 100. The first controlling-room cover 15 has a first heat-fin set 151 and at least one power-input port 150.

The second controlling-room cover 14 is furnished to another side of the housing 10 so as to seal the second controlling room 101. The second controlling-room cover 14 has a second heat-fin set 140.

The stator housing 21, disposed inside the housing 10, has at least one stator-cooling channel 210. The stator-cooling channel 210 is connected spatially with the cooling outlet 11 and the cooling inlet 12. In this disclosure, the stator-cooling channel 210 can be a water-cooling channel, a liquid-cooling channel or an air-cooling channel. Also, the aforesaid first controlling room 100 and second controlling room 101 are both disposed to opposing outer sides of the stator housing 21 in a radial direction of the stator housing 21.

Each of the stator housing 21, the first controlling-room cover 15 and the second controlling-room cover 14 can be made of a metallic or metal-contained material.

The stator set 20 is located inside the stator housing 21. In addition, the rotor set 19 is mounted at the spindle 16, and both the rotor set 19 and the spindle 16 are disposed inside the stator housing 21, and also inside the stator set 20. The rotor set 19 has at least one rotor-cooling channel 190. The rotor-cooling channel 190 can be a water-cooling channel, a liquid-cooling channel or an air-cooling channel

The stator-cooling channel 210, the stator set 20, the rotor set 19 and the spindle 16 are all arranged inside the stator housing 21 in an inward order. One end of the spindle 16 is furnished with the rear bearing 130, while another end of the spindle 16 protrudes out of the stator housing 20 and the housing 10 and is there furnished with a front bearing 102.

The cooling fan 22, located inside the stator housing 21, is connected with the end of the spindle 16 that protrudes out of the housing 10, so that the cooling fan 22 can be driven by the spindle 16.

The first drive controller 18, located in the first controlling room 100, is electrically coupled with the power-input port 150. The first drive controller 18 has a capacitor module 180, a power module 181, a current-detecting module 182 and a conductive plate 183, in which the conductive plate 183 is connected with the stator set 20.

The first drive controller 18 can be fixed to the stator housing 21, or fixed to the first controlling-room cover 15 as shown in FIG. 3.

The second drive controller 17, located in the second controlling room 101, is electrically coupled with the first drive controller 18. The second drive controller 17 has a control module. In a further discussion, the control module is electrically coupled with the power module 181 and the current-detecting module 182. In this embodiment, the wire is wrapped with an anti-electromagnetic material or a heat-conductive electricity-insulating adhesive.

The second drive controller 17 can be fixed to the stator housing 21 or the second controlling-room cover 14.

Referring now to FIG. 1 through FIG. 5, the cooling inlet 12 can provide cooling water, cooling air or cooling fluid to the stator-cooling channel 210, so that the stator set 20 in operations can be cooled down. After being heat exchanged, the cooling water, the cooling air or the cooling fluid can be exhausted out of the housing 10 via the cooling outlet 11.

Since the cooling fan 22 is driven by the spindle 16 that is driven by the rotor set 19, the cooling fan 22 can provide cold air to the rotor-cooling channel 190 so as to cool down the rotor set 19 in operations, or supply the cold air directly to both the rotor set 19 and the stator set 20 so as to cool down both the rotor set 19 and the stator set 20 in operations.

In the case that the rotor-cooling channel 190 is a liquid-cooling channel, then the rotor-cooling channel 190 can connect spatially the aforesaid cooling outlet 11 and cooling inlet 12, such that the cooling fluid from the cooling inlet 12 can flow into the rotor-cooling channel 190, and leave via the cooling outlet 11.

The power-input port 150, connected electrically with a power source, is to run the first drive controller 18. Heat generated by the running first drive controller 18 can be dissipated out of the housing 10 by the first heat-fin set 151, so that the temperature of the first drive controller 18 can be reduced. Similarly, heat generated by the running second drive controller 17 can be dissipated out of the housing 10 by the second heat-fin set 14, so that the temperature of the second drive controller 17 can be reduced.

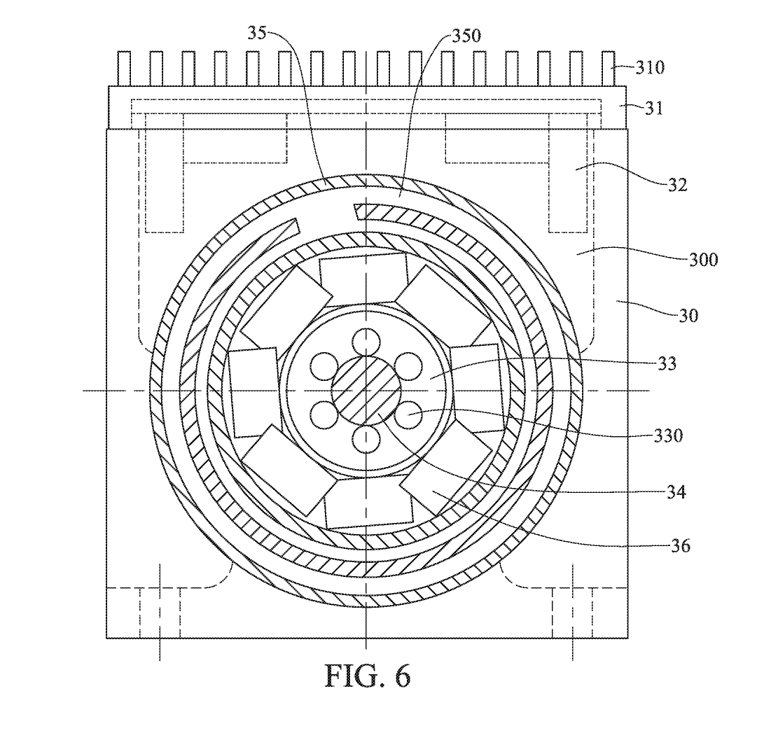

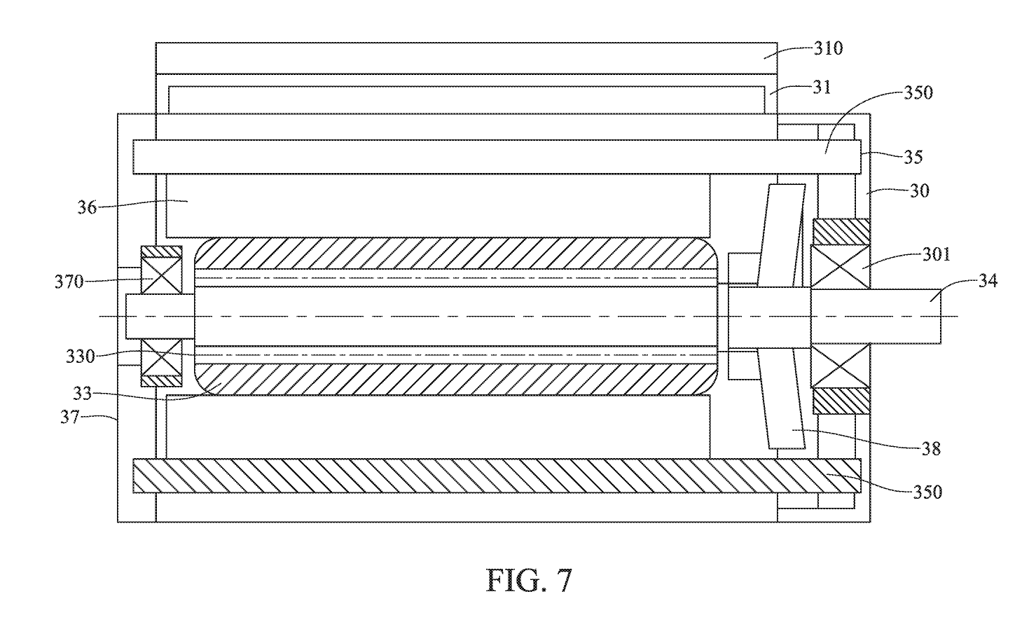

Referring now to FIG. 6 and FIG. 7, a second embodiment of the electric rotating machine in this disclosure is shown. In this embodiment, the electric rotating machine includes a housing 30, at least one controlling-room cover 31, at least one drive controller 32, a rotor set 33, a spindle 34, a stator housing 35, a stator set 36, a rear bearing seat 37 and a cooling fan 38.

The housing 30 has at least one controlling room 300. The controlling-room cover 31, disposed at one side of the housing 30, is to seal the controlling room 300. In addition, the controlling-room cover 31 has a heat-fin set 310.

The rear bearing seat 37, located at one end of the housing 30, has a rear bearing 370.

The drive controller 32 is located inside the controlling room 300. The controlling room 300 has thereinside a filler. In this embodiment, the filler can be a heat-conductive electricity-insulating adhesive. The drive controller 32 has a plurality of circuit modules. These circuit modules can be the capacitor module, the power module, the current-detecting module or the control module, as described already in the first embodiment.

In one exemplary example, the drive controller 32 is fixed to the controlling-room cover 31, and the controlling room 300 has thereinside a heat-conductive electricity-insulating adhesive or an anti-electromagnetic material.

In another exemplary example, the drive controller 32 is fixed to the housing 35 at a place radially aside to the stator housing 35. The controlling room 300 has thereinside a heat-conductive electricity-insulating adhesive or an anti-electromagnetic material.

In a further exemplary example, the drive controller 32 is disposed between the controlling room 300 and the controlling-room cover 31. The controlling room 300 has thereinside a heat-conductive electricity-insulating adhesive or an anti-electromagnetic material.

The stator housing 3, located inside the housing 30, has at least one stator-cooling channel 350. The rotor set 33 is mounted at the spindle 34. The stator set 36 is located at a circumference of the rotor set 33.

The stator-cooling channel 350, the stator set 36, the rotor set 33 and the spindle 34 are all arranged inside the stator housing 21 in an inward order. The rotor set 33, located at the spindle 34, has at least one rotor-cooling channel 330. One end of the spindle 34 is received by the rear bearing 370, while another end thereof is protruded out of the stator housing 35 and the housing 30. The protrusive end of the spindle 34 is connected with a front bearing 301.

In summary, according to this disclosure, the circuit module (the first drive controller or the drive controller), separated from the control module (the second drive controller or the drive controller) distantly, is disposed inside the controlling room of the stator housing. Thus, the control module would be free from the electromagnetic interference by the stator set, and the circuit modules that contribute a larger temperature difference and broadcast different electromagnetic radiation will not interfere each other. Thereupon, tightness in the entire spatial arrangement of the electric rotating machine can be substantially increased without sacrificing the production quality.

In this disclosure, at least one controlling room is located radially aside to the stator; such that structural symmetry of the stator housing can be obtained, and thus the spatial arrangement can be efficient. In the circumstance of providing a plurality of controlling rooms to accommodate individual circuit modules with different functions and/or different work temperatures, then the circuit module and the control module of the same drive controller can be separately located so as to form isolated shielding. Thereupon, possibility of thermal damage upon electronic components and the electromagnetic noise interference rate can be substantially reduced.

Since structuring of the electric rotating machine in this disclosure is symmetric, thus no over weighting at any side of the machine can exist, and thereby arrangement in the applicable space can be much easier.

By providing the design of multiple controlling rooms in this disclosure, then circuit modules with different functions and/or different work temperatures in the same drive controller can be separated and constructed individually into different controlling rooms, such that the electromagnetic noise interference and the thermal interference upon the circuit module and/or the control module can be effectively reduced. Thereupon, reliability and quality control of the drive controller can be enhanced, and individual arrangements of cooling devices for the high-temperatured power modules can be carried out, so that the heat-dissipating efficiency of the entire machine can be significantly raised.

With respect to the above description then, it is to be realized that the optimum dimensional relationships for the parts of the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present disclosure.

What is claimed is:

1. An electric rotating machine, comprising:
a stator housing;
a rotor set, located inside the stator housing;
a stator set, located inside the stator housing by surrounding the rotor set;
at least one controlling room, located aside to the stator housing; and
at least one drive controller, located inside the controlling room.

2. The electric rotating machine of claim 1, wherein the at least one controlling room includes a plurality of controlling rooms located radially aside to the stator housing.

3. The electric rotating machine of claim 1, further including at least one controlling-room cover for sealing the controlling room.

4. The electric rotating machine of claim 3, wherein the controlling-room cover has a heat-fin set.

5. The electric rotating machine of claim 3, wherein the at least one drive controller is fixed to the controlling-room cover.

6. The electric rotating machine of claim 1, further including a spindle and a cooling fan, wherein the rotor set is mounted on the spindle, the rotor set has at least one rotor-cooling channel, and the cooling fan is connected with one end of the spindle.

7. The electric rotating machine of claim 6, wherein the rotor-cooling channel is one of a liquid-cooling channel and an air-cooling channel.

8. The electric rotating machine of claim 1, wherein the drive controller is fixed to the stator housing.

9. The electric rotating machine of claim 1, wherein the stator housing has at least one stator-cooling channel

10. The electric rotating machine of claim 9, wherein the stator-cooling channel is one of a water-cooling channel, a liquid-cooling channel and an air-cooling channel.

11. The electric rotating machine of claim 1, wherein the drive controller has a plurality of circuit modules.

12. The electric rotating machine of claim 1, wherein the controlling room has thereinside a filler.

13. The electric rotating machine of claim 12, wherein the filler is a heat-conductive electricity-insulating adhesive.

14. The electric rotating machine of claim 1, wherein the at least one controlling room includes a plurality of controlling rooms having holes for connection wires to pass therethrough.

15. The electric rotating machine of claim 3, wherein each of the stator housing and the controlling-room cover is made of one of a metallic material and a metal-contained material.

16. An electric rotating machine, comprising:
a stator housing;
a rotor set, located inside the stator housing;
a stator set, located inside the stator housing by surrounding the rotor set;
at least one controlling room, located aside to the stator housing; and
at least one drive controller, located inside the controlling room; and
at least one controlling-room cover, sealing the controlling room.

17. The electric rotating machine of claim 16, wherein the at least one controlling room includes a plurality of controlling rooms located radially aside to the stator housing.

18. The electric rotating machine of claim 16, wherein the controlling-room cover has a heat-fin set.

19. The electric rotating machine of claim 16, wherein the at least one drive controller is fixed to the controlling-room cover.

20. The electric rotating machine of claim 16, further including a spindle and a cooling fan, wherein the rotor set is mounted on the spindle, the rotor set has at least one rotor-cooling channel, and the cooling fan is connected with one end of the spindle.

21. The electric rotating machine of claim 20, wherein the rotor-cooling channel is one of a liquid-cooling channel and an air-cooling channel.

22. The electric rotating machine of claim 16, wherein the drive controller is fixed to the stator housing.

23. The electric rotating machine of claim 16, wherein the stator housing has at least one stator-cooling channel.

24. The electric rotating machine of claim 23, wherein the stator-cooling channel is one of a water-cooling channel, a liquid-cooling channel and an air-cooling channel.

25. The electric rotating machine of claim 16, wherein the drive controller has a plurality of circuit modules.

26. The electric rotating machine of claim 16, wherein the controlling room has thereinside a filler.

27. The electric rotating machine of claim 26, wherein the filler is a heat-conductive electricity-insulating adhesive.

28. The electric rotating machine of claim 16, wherein the at least one controlling room includes a plurality of controlling rooms having holes for connection wires to pass therethrough.

29. The electric rotating machine of claim 16, wherein each of the stator housing and the controlling-room cover is made of one of a metallic material and a metal-contained material.
